(19) United States
(12) Patent Application Publication
(10) Pub. No.: US 2026/0332646 A1
(43) Pub. Date: Oct. 22, 2026

(54) SYSTEM AND METHODS FOR DECENTRALIZED INTELLIGENCE NETWORKS

(71) Applicant: AnyLog, Inc., Redwood City, CA (US)

(72) Inventors: Moshe Shadmon, Redwood City, CA (US); Roy Shadmon, Redwood City, CA (US)

(21) Appl. No.: 19/468,999

(22) Filed: Feb. 3, 2026

Related U.S. Application Data
(60) Provisional application No. 63/754,411, filed on Feb. 5, 2025.
(60) Provisional application No. 63/815,861, filed on Jun. 1, 2025.
(60) Provisional application No. 63/859,563, filed on Aug. 7, 2025.

(51) Int. Cl. H04L 9/40; G06F 21/62

(52) U.S. Cl. CPC H04L 63/20; G06F 21/6218

(57) ABSTRACT

Systems and methods for decentralized intelligence networks are disclosed herein. In one embodiment the invention may comprise a method of federated learning with improved data security. The method may be operable on a network of nodes wherein each node includes a computer system comprising at least a processor, a memory and a computer program comprising processor-executable instructions stored on a non-transitory processor readable medium. A requesting node may publish an initial global model to a shared metadata layer. An edge node may retrieve the initial global model and generate a sub-model using data stored locally. The edge node may then publish the sub-model to the shared metadata layer. An aggregator node may generate a final global model based on the sub-model.

### CROSS-REFERENCE TO RELATED APPLICATIONS

This application claims the benefit of U.S. Provisional Application No. 63/754,411, filed Feb. 5^{th}, 2025, U.S. Provisional Application No. 63/815,861, filed Jun. 1^{st}, 2025, and U.S. Provisional Application No. 63/859,563, filed Aug. 7^{th}, 2025 all of which are hereby incorporated by reference, to the extent that they are not conflicting with the present application.

### BACKGROUND OF INVENTION

### 1. Field of the Invention

The invention relates generally to data management and machine learning. Specifically, the invention relates to data management and machine learning within decentralized networks.

### 2. Description of the Related Art

Current manufacturing environments and machine learning protocols rely heavily on centralized supervisory control and data acquisition (SCADA) and cloud-based architecture. In these setups, data must be transferred from machines to centralized cloud platforms for processing, analysis, and coordination. This transfer of data to centralized clouds or servers introduces latency, limits scalability, exposes sensitive operational data, and creates a single point of dependency that hinders reliability, fault-tolerance, and real-time responsiveness. Similarly, present solutions for distributed automation via machine-to-machine (M2M) communication are limited in scope and effectiveness. Present solutions similarly lack scalability, fault-tolerance, and flexibility. Other solutions are built on proprietary and/or non-interoperable software and protocols which lead to fragmentation and vendor lock-in. Present solutions may additionally be difficult to manage and scale in heterogeneous industrial environments. As manufacturers progress towards completely automated (“lights-out”) factories, present solutions are insufficient.

There are currently no adequate solutions to the aforementioned computer related technological problems. Therefore, there is a need to solve the problems described above by providing improved systems and methods for decentralized intelligence networks.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The present system and methods for decentralized intelligence networks may comprise some or all of the following components. Network machines/devices (e.g., industrial manufacturing sensors, robotics, automation systems) may gather data to be sent to associated edge nodes (e.g., mobile devices, compute devices). Edge nodes may comprise artificial intelligence (AI) programs (also “artificial intelligence agents”, “AI agents”, “autonomous agents”, “agents”) implemented as executable software modules that load and run trained models, including but not limited to neural networks, statistical models, or decision logic. The AI programs may process locally ingested data (e.g., from machines, sensors, cameras, other AI programs and more) to generate inferences, predictions, classifications, or control decisions, and may exchange data, model outputs, blob objects (e.g., JSON data), files, or metadata with other nodes in the network to enable coordinated, multi-node behavior while keeping raw data local to each edge node. Nodes may access a shared metadata layer (which may be implemented in many different ways, for example as a “decentralized ledger”, or using a “blockchain”, or in a centralized way such as in a database) to determine which nodes are associated with which machines, which nodes store certain data, security policy information, access permission, network machine model versions and more. In the present invention, the data collected by machines need not ever be transferred, the raw data in combination with the location information specified in the shared metadata layer creates what will be referred to herein as the virtual data layer (or “virtual data lake”). The virtual data layer, which abstracts raw data distributed across the network while storing data location and access information in a shared metadata layer, provides many of the functional benefits of centralized or cloud-based architectures without their associated drawbacks. When a query is initiated in or to the network, the query is provided to a node that operates as an orchestration node. The orchestration node examines shared metadata associated with the network to identify one or more edge nodes that store data relevant to the query. The orchestration node then transmits the query to the identified edge nodes, receives result sets generated locally at each participating edge node, and aggregates the received result sets into a unified response returned to a requesting entity.

The above-mentioned process enables a query to be issued against distributed data while returning a query result as though the query were executed on a centralized database. In some embodiments, the edge nodes identified to satisfy the query, together with the orchestration node, dynamically form an overlay network (also referred to as an “overlay subnetwork” or “subnetwork”). The overlay network comprises a logical grouping of a subset of nodes selected from the broader network for the duration of the query or task. Communication among nodes participating in the overlay network may be optimized relative to communication with non-participating nodes, thereby improving efficiency, scalability, and security. The overlay network may be created in response to the query described above or in response to other tasks, including but not limited to applications, AI agents, and users requesting data, machine learning model training, distributed inference, data aggregation, or coordination among artificial intelligence programs executing at the edge nodes. The overlay network may be formed on demand, maintained only for the duration of the query or task, and dissolved or reconfigured upon completion, without requiring changes to the underlying physical or logical network topology. In some embodiments, communication within the overlay network is restricted to participating nodes and may employ task-specific authentication, authorization, or encryption mechanisms distinct from those used in the broader network.

In some embodiments, the system and methods may additionally comprise dynamic software artifact deployment and lifecycle management tools (e.g., containers, micro-services WASM modules).

In some embodiments, the system may additionally provide a mailbox channel; a secure per-node control memory-persisted inbox that allows authorized participants to push messages, instructions, configuration changes, state updates, or actuation commands directly to edge nodes—even when those nodes are intermittently connected.

A shared metadata with the virtual data layer may provide the ability for agents executing on edge nodes, and in communication with edge machines and devices, to monitor system activities and to reason, coordinate, and act using globally visible but locally stored data. The agents may further coordinate with one another to perform system-wide adaptations based on such data or instructions. The ability for agents to query the needed data and operate against shared metadata, thereby making decisions based on globally visible data, increases the degree of automation achievable within the system. This capability allows an agent to obtain, interpret, and utilize data hosted on distributed edge nodes or computing environments in a logically unified manner, without regard to the physical location, ownership, or storage modality of the data, thereby enabling consistent, scalable, and automated decision-making across the system.

The disclosed system and methods provide for automated federated learning within decentralized network environments. The system may dynamically manage training rounds, optimize communication efficiency, and enforce secure aggregation protocols. The system may further support distribution of one or more models, model parameters, or updates to participating nodes, as well as rollback, replacement, or version control of such models during or between training rounds. In addition, the system may dynamically adjust training configurations, communication strategies, aggregation behaviors, or participation criteria within a given training round. By integrating automated model updates, performance monitoring, and adaptive resource allocation, the approach enhances scalability and minimizes manual intervention in federated learning workflows.

In one embodiment the method of federated learning may comprise the following steps. First, an initial model (“initial global model”, “initial training model”, “base model”) may be created and published to the shared metadata, making it available for edge nodes to access. Next, the edge devices or nodes may access the shared metadata that identifies the location, access method, or retrieval mechanism for the initial training model, and may obtain or pull the initial training model based on such metadata. The edge nodes may query their own local data and perform model training locally, generating a sub-model based on the base model and its unique dataset. The location, access method, or retrieval mechanism of the sub-models generated by each edge node may then be published back to the shared metadata repository. These sub-models represent the locally trained results without exposing the underlying data. Next, the aggregation of the published sub-models may create the final model. Any edge node or a dedicated aggregator node may pull all sub-models (most recent sub-model from each device/node) using the retrieval mechanism specified in the shared metadata. The sub-models may then be combined into a final model using federated averaging or other aggregation techniques. The retrieval mechanism and metadata of the final model may then be published to the shared metadata for all nodes to access. Lastly, each node may pull the final model using the retrieval mechanism(s) specified in the shared metadata and may apply the final model locally on the edge node’s data for inference and decision making.

In some embodiments, the shared metadata may include or reference shared storage or temporary shared storage used to manage, stage, or distribute large files, such as artificial intelligence models or related artifacts.

Each node may additionally operate as an inference node, wherein one or more inputs are received from a peer node, a neighboring node, a local process, or another data ingestion mechanism, and the inference node generates an inference, prediction, or other model output in response. In some embodiments, an inference node comprises an edge or other computing resource that did not participate in a corresponding training process and is configured to receive, obtain, or otherwise access an aggregated, trained, or partially trained model for execution of inference operations. This method enables AI based decision making without moving the data to a centralized location and without compromising data security to train an AI model.

The federated learning methods described herein enable distributed model training without introducing dependencies or direct communication between participating edge nodes. Each edge node publishes retrieval instructions, metadata, or references identifying how a sub-model or model update may be accessed, and independently retrieves model information from a shared metadata layer, without requiring knowledge of, synchronization with, or interaction with other edge nodes. As a result, participation is fully decoupled across nodes, supports asynchronous operation, and is resilient to changes in node availability without requiring point-to-point coordination.

The methods described herein further transform the network from a passive data transport mechanism into a data-aware network. By exposing data, models, and model outputs through shared metadata and a virtual data layer, the network maintains awareness of the existence, location, structure, and topology of the metadata, distributed data, and derived artifacts. Queries, tasks, and artificial intelligence programs may therefore be routed, executed, and optimized based on data awareness rather than fixed endpoints or static routing rules. As a result, computation, learning, and decision-making occur in proximity to relevant data sources, enabling intelligent, context-aware network behavior without centralizing data. Unlike conventional networks that operate solely on packet-level addressing and transport semantics, the network described herein incorporates data and network topology awareness into its operation, allowing tasks and intelligence to be driven by data characteristics rather than node identifiers alone. This data awareness enables federated learning, inference, and agent coordination to be initiated and managed at the network level, with nodes dynamically participating based on the data they host, the services they manage, and the tasks being performed.

The objects of the present system and methods for decentralized intelligence are improved consistency, scalability, flexibility and efficiency. It is an object of the present system and methods for decentralized intelligence networks to provide for reduced network overhead bandwidth and improved security by providing the ability to store, retrieve and process data without ever having to transmit or move that raw data. It is an object of the present system and methods to provide for improved scalability by streamlining the process of adding new machines and nodes to the network. It is an object of the invention to ensure consistent distributed operation by maintaining a unified and synchronized metadata view across all nodes in the network. It is an object of the invention to support both fully decentralized and semi-centralized deployment models, catering to different operational requirements. It is an object of the invention to provide high network availability through redundancy, fault tolerance, and continued operation in the presence of component, network, or node failures. Furthermore, it is an object of the invention to improve efficiency in a distributed network by having a shared metadata, reducing redundant queries and unnecessary duplication of data across nodes.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIGS. 1A-B each depict a block diagram demonstrating a method of federated learning, according to an aspect.

FIGS. 2A-B each depict a block diagram of system architecture, according to an aspect.

FIGS. 3A-B each depict a block diagram of system architecture, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

### GLOSSARY

It may be beneficial to set forth the definition of several terms that will be used throughout the course of this application.

As used herein and throughout this disclosure the term “edge node” may be used to refer to a computing device at the ‘edge’ of a network. This term may be used to describe any computing device that operates outside of cloud-based infrastructure, and may encompass devices with varying levels of compute, storage, and networking capabilities. An edge node may exist in close physical proximity to an edge device (e.g., data sources, internet of things (IoT) devices, sensors, local servers, switches, gateways). Edge nodes may process analyze and store data locally, thereby reducing the need to transfer data to central cloud servers. Edge nodes may be utilized in real-time decision making, enhancing privacy, as well as to reduce latency and bandwidth costs.

The term “training application” may be used to refer to software designed to facilitate the development and training of machine learning models. Training applications may provide the necessary functionalities to preprocess data, define model architectures, execute training algorithms and evaluate performance metrics. Training applications are commonly used in both centralized and decentralized systems (e.g., federated learning architectures and traditional machine learning architectures) to create models tailored to specific tasks (e.g., image recognition, natural language processing (NLP) or predictive analysis).

The term “artificial intelligence (AI) model” (“AI model”, “AI agent”, “autonomous agent”, “agent”) may be used to revere to a computational program to simulate intelligent behavior by recognizing patterns from provided training data. AI models may utilize specially trained algorithms to perform tasks such as classification, prediction recommendation, and decision making. AI algorithms may also be used in the generation, transformation, interpretation, or evaluation of natural language or other structured or unstructured data. AI models may utilize linear regression, deep learning architectures (e.g., neural networks), large language models (LLMs) (e.g., GPT5, Claude, Llama), or similar. Once trained they may process new input to generate outputs or make decisions. Example use cases include chatbots, autonomous systems or image recognition tools.

A “sub-model” is a smaller, localized machine learning model (AI model) that is generated, trained, or updated based on locally available data or a subset of data that may contribute, directly or indirectly, to the formation, updating, or refinement of a primary model. In distributed or federated learning contexts, sub-models capture patterns and insights specific to their local environment. They may later be aggregated into a “final model” (also “global model”). This may enable node network collaborative learning capabilities without sharing raw data, enhancing privacy and reducing system data transfer. A sub-model and a primary model may exhibit equivalent functional capabilities; however, in a federated learning context, a primary model represents an aggregation, combination, or consolidation of parameters derived from a plurality of sub-models, which may result in improved or enhanced model performance relative to an individual sub-model.

In the context of this application, the phrase “aggregation process” may be used to refer to a process in federated learning which involves combining (aggregating) multiple sub-models or sub-model parameters (e.g., weights, biases) from distributed edge nodes into a single unified global (final) model. Aggregation processes may comprise techniques such as federated averaging (FedAvg) where the contributions of each sub-model are weighted based on sub-model parameters (e.g., size, quality of training sets of each sub-model). In some embodiments, differential privacy or other privacy-preserving techniques may be applied to one or more sub-models, model parameters, or model updates prior to sharing, transmission, or aggregation, thereby enhancing security and reducing the risk of sensitive information disclosure.

The “final model” (also “global model”) in a federated learning context, is the result of the aggregation process. The final model represents a fully trained and optimized machine learning model ready for deployment. In federated learning, the final model is obtained after aggregating sub-models from distributed edge nodes. The final model may combine insights from all participating nodes without requiring direct access to their local data, ensuring privacy and efficiency. The final model may then be distributed back to the edge nodes for inference or further fine-tuning, enabling real-world applications like prediction, decision-making, or automation. The final model may be continuously updated.

“Agentic artificial intelligence” (also “agent AI” or “autonomous agent” or “agent”) may be used to refer to AI systems capable of autonomous interaction with the environment, issuing queries and making decisions in real time. “Agentic AI” may also refer to artificial intelligence embodied as autonomous software agents that can observe data, reason over that data, and take actions to achieve objectives, including initiating tasks and coordinating with other agents, without centralized control. Agentic AI is distinct from passive or reactive AI systems in that agentic AI is capable of proactively initiating actions and managing tasks based on internal decision logic rather than solely responding to externally triggered requests.

“Audit trail” may be used to refer to a chronological record maintained on the blockchain to ensure traceability and accountability of operations.

“Bandwidth” may be used to refer to the maximum rate at which data can be transmitted over a network connection, typically measured in bits per second (bps). In distributed edge networks, bandwidth consumption refers to the amount of data transferred between nodes or between edge nodes and central systems, impacting latency, operational cost, and network efficiency.

A “blockchain-based metadata layer” may refer to a distributed ledger that maintains metadata such as data location, schema definitions, access control policies, and audit trails, thereby enabling decentralized governance and coordinated operation across network nodes.

“Cloud independence” may refer a system’s ability to function without centralized cloud infrastructure, preserving autonomy and minimizing latency.

“Data fabric” may refer to an architectural approach that provides seamless data management and access across distributed and heterogeneous environments through virtualization and orchestration.

“Data ingestion” may refer to the process of collecting and receiving data at edge nodes for storage and indexing to enable query and analysis.

“Data locality” may refer to the principle of processing data as close to its source as possible to satisfy locality regulations and reduce latency and bandwidth consumption.

“Data sovereignty” may refer to the ability to manage, query, store, and access data while maintaining control over data location, governance, and usage.

“Decentralized federated learning” may refer to a distributed machine learning training method in which model training occurs collaboratively across multiple edge nodes without relying on a centralized aggregator. Each node trains a local model on its private data and then exchanges model updates (e.g., weights or gradients) directly with peer nodes. Instead of relying on a dedicated aggregator node, each node may independently perform local aggregation using sub-models or model updates obtained from all or a selected subset of peer nodes.

“Decentralized physical infrastructure network (DePIN)” may refer to a system or network in which ownership, operation, coordination, or governance of physical infrastructure resources—such as computing, storage, networking, sensing, or energy resources—is distributed across multiple independent participants and managed through decentralized coordination mechanisms rather than a single centralized authority.

“Decomposition (of queries)” may refer to the process of breaking a high-level query into smaller subqueries executed locally at relevant edge nodes.

“Distributed ledger” may refer to a blockchain-based system used to store synchronized metadata and policies in a decentralized manner.

“Distributed query execution” may refer to automated execution of different parts of a query across multiple edge nodes or computing resources, and the aggregation, combination, or coordination of the resulting outputs.

“Edge analytics” may refer to the real-time processing and analysis of data at or near the edge nodes where data is generated.

“Egress” may refer to data moving outside the environment in which it is managed, stored, and queried from.

“Fault tolerance” may refer to the ability of the network to continue operating correctly even when some nodes or communication paths fail.

“Federated learning” may refer to a distributed machine learning approach in which multiple computing nodes collaboratively train or update a model by processing data locally and sharing model parameters, updates, or derived information, rather than raw data, with one or more coordinating entities or processes.

“Horizontal scalability” may refer to the ability to seamlessly add new, actively participating nodes to the P2P network.

“Industrial internet of things” (also “IIOT”) may refer to networks of industrial devices such as sensors and PLCs that generate operational data.

“Immutable ledger” may refer to a recordation mechanism (e.g., blockchain ledger) in which recorded entries are resistant to modification or deletion after being written, thereby providing assurances of data integrity, traceability, and non-repudiation, independent of any particular underlying implementation.

“Data indexing” (also “indexing) may refer to the organizing of data to support efficient query execution and retrieval.

“Inference” may refer to the run-time process of applying a machine-learning model to new, previously unseen input data in order to generate predictions, classifications, decisions, or other task-specific outputs. Inference consumes the model’s learned parameters (e.g., weights, coefficients) but does not modify them; its purpose is real-time or batch evaluation rather than further training.

“Ingress” may refer to the entry point or process of incoming data into a system or network. For example, data flowing into the cloud or a centralized system from edge devices or external network traffic entering a system through APIs, data ports, or protocols.

“Intent-based data access” may refer to a data access model in which a user or AI agent specifies a desired outcome or information need, rather than issuing detailed queries tied to specific data locations, formats, or endpoints. The system interprets this intent, dynamically routes the request to the appropriate edge nodes, and executes it locally.

“Intent-based query” may refer to a query model where the software interprets the user’s or AI’s intended goal rather than explicit data retrieval commands, enabling dynamic query optimization.

“Local autonomy” may refer to the capability of each edge node to operate independently, including data processing and decision-making, without central coordination.

“Machine learning” (also “ML”) may refer to a class of computational techniques in which a system improves its performance on a task by extracting patterns from data rather than following only explicitly programmed rules. Machine-learning methods include—without limitation—supervised learning (e.g., classification, regression), unsupervised learning (e.g., clustering, dimensionality reduction), semi-supervised learning, reinforcement learning, and ensemble or transfer-learning approaches.

“Machine learning model” may refer to a parameterized mathematical construct that encapsulates learned weights, coefficients, or decision boundaries that can be executed (inferred) on new, previously unseen inputs to produce outputs consistent with the task for which it was trained.

“MCP protocol (Model Context Protocol)” may refer to a communication protocol that defines standardized mechanisms for exchanging context, requests, responses, and control information between models, agents, applications, and external systems, thereby enabling coordinated operation, interoperability, and structured interaction across heterogeneous computing environments.

“MCP server” may refer to a computing system or service configured to implement a Model Context Protocol (MCP), and to facilitate structured communication, coordination, or data exchange between one or more models, agents, applications, or external systems, including managing context, requests, responses, or control information in accordance with the protocol.

“Metadata” may refer to data describing the structure, source, semantics, location, ownership, lineage, and access policies or permissions associated with other data, models, or operations. Such metadata may be maintained in a shared or distributed repository and synchronized across the network to enable discovery, governance, orchestration, and policy enforcement. In the context of the invention, the metadata may further include information shared among nodes, including, by way of example, storage location of artifacts, artificial intelligence models, model parameters, version identifiers, or references identifying the location of such models within the network.

“Metadata synchronization” may refer to the process of keeping metadata up to date across all participating edge nodes in the network.

“Native protocol service” may refer to a service module registered within the peer-to-peer network that can be directly invoked using the network’s native messaging and routing protocols. Once registered, it operates as a built-in, discoverable function accessible across edge nodes without external APIs or orchestration.

An “original equipment manufacturer” (also “OEM”) is a company that produces hardware or software components that are used in another company's end products. In industrial and edge computing contexts, OEMs typically manufacture devices, such as sensors, PLCs, gateways, robotic systems, and embedded processors.

“Orchestrator” (sometimes “orchestrator node”) may refer to a control component (e.g., software or service) that discovers, coordinates, schedules, and manages the lifecycle of distributed resources or tasks to achieve a desired system-wide outcome.

“Overlay networks” (also “overlay” or “subnetwork”) may refer to a logical communication layer built on top of an existing physical or data-link network. It interconnects a selected subset of participating nodes (often dynamically and according to task-specific criteria) by using the underlying network only for packet transport while implementing its own address space, routing scheme, and control protocols.

“Peer discovery” may refer to the mechanism through which new nodes identify and connect with existing nodes in a decentralized network.

“Peer-to-peer network” (also “P2P Network”) may refer to decentralized network in which each node (agent) communicates directly with others without a central server.

“Permissioned network” may refer to a type of blockchain or P2P network where only authorized participants can join and interact.

“Plug-and-play deployment” may refer to the ability to integrate edge devices and services with minimal manual configuration.

“Private key” may refer to a cryptographic value or secret information that is maintained under the control of an entity and used to perform cryptographic operations, such as decryption, signing, or authentication, and that is not intended to be disclosed to unauthorized parties, including in implementations based on an RSA algorithm.

“Programmable logic controller” (also “PLC”) may refer to an industrial computer that has been ruggedized and adapted to function reliably under extreme industrial conditions and configured for the control, monitoring, and automation of manufacturing processes, such as assembly lines, machines, robotic devices, or other physical operations, including pulling data from, managing, and automating manual or semi-automated processes while supporting high reliability, ease of programming, and process fault diagnosis.

“Public key” may refer to a cryptographic value that is mathematically related to a corresponding private key and that may be distributed or made accessible to one or more entities for use in cryptographic operations, such as encryption, signature verification, or secure key exchange, including in implementations based on an RSA algorithm.

A “Query” may refer to a structured or unstructured request, instruction, command, or expression, including but not limited to a SQL query, that is issued to obtain data, invoke computation, trigger analysis, update a machine status, or request execution of one or more operations across one or more computing systems.

“Query optimization” may refer to the process of improving the efficiency of query or task execution, often by minimizing data transfer, computational load, execution latency, and may further include identifying, selecting, and routing queries, or portions thereof, only to computing nodes determined to be relevant for satisfying the querying.

In the context of this application, “Query planning” may refer to the process of identifying the edge nodes hosting relevant data based on the query or task.

“Query routing” may refer to the process of directing subqueries or subtasks to appropriate edge nodes based on metadata.

“Real-time automation” may refer to the automatic execution of operational workflows based on real-time data and analytics at the edge.

“Real-time inference” may refer to the process of running machine learning models directly at the edge node as data is generated, those machine learning models analyzing current edge data and performing (or ordering) actions to be taken by one or more machines/devices in response.

“Data replication” may refer to the process of duplicating data or state across multiple nodes to improve availability and fault tolerance.

“RSA” may refer to a public-key cryptographic algorithm based on the computational difficulty of factoring large integers, and may be used for encryption, decryption, digital signatures, or key exchange by employing a public key and a corresponding private key.

A “schema” may refer to a formal definition of the structure and type of data collected and queried.

A “self-organizing protocol” may refer to a mechanism that allows new edge nodes to automatically discover, register, and integrate into the network.

A “service module” may refer to a functional component registered on an edge node to perform tasks such as inference or access control.

A “smart contract” may refer to a blockchain program that enforces access control, query authorization, or policy compliance automatically.

“Service discovery” may refer to a protocol enabling nodes to find and communicate with registered service modules within the network.

“Throughput” may be used to refer to the amount of data that can be processed or transmitted by the system within a given time frame.

“Unified namespace” may refer to a logical abstraction that presents data, resources, or services from multiple underlying edge nodes, systems, or locations, as a single, logical addressable space, independent of physical storage, network topology, or ownership boundaries.

“Unified programmable environment” may refer to a virtual abstraction of the distributed edge infrastructure presented as a single system.

“Virtualized data access layer” may refer to the combination of raw data housed on edge nodes/devices and that data’s location information broadly available on the shared metadata layer. The virtualized data access layer may refer to a metadata-based abstraction that allows querying distributed data as if it were in a centralized database.

As used herein and throughout this disclosure, the term "mobile device” refers to any electronic device capable of communicating across a mobile network. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, and Wi-Fi transceivers.

"Logic" as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile devices may communicate with each other and with other elements via a network, for instance, a cellular network. A "network" can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH.RTM. networks, with communication being enabled by transceivers. A network typically includes a plurality of elements such as mobile devices that host logic for performing tasks on the network.

“Virtual data lake” refers to a logical data abstraction provided by the system of the invention that enables access to, querying of, and operations on distributed data as if the data were stored in a single, centralized data repository, while the data remains physically stored at multiple, geographically or logically distributed edge nodes. The virtual data lake provides centralized-like data visibility and operability without requiring data movement, duplication, or consolidation, thereby enabling scalable analytics, agentic artificial intelligence, and federated learning over distributed edge data.

### INVENTION SUMMARY

The system and methods for decentralized intelligence may comprise machines and industrial assets (e.g., CNCs, PLCs, robotics, compressors, sensors), which may each generate continuous streams of data such as telemetry, operating status, diagnostics, and control feedback. These machines may operate independently or as part of larger production workflows. Each of these machines may be associated with a node stored directly on or near the machine. Each node may connect to machine data sources (e.g., PLCs, sensors, OPC UA server, controllers, cameras) and may extract, store and process the data locally. These nodes may additionally provide connectivity and local execution capabilities without ever forwarding raw data. The distributed nodes collaboratively form the virtual data layer (also “virtual data lake” or “data fabric”) a logical abstraction which represents all locally stored data as if it resides in a single, centralized database, while the data physically remains on the originating node. Each node may expose its data, including data stored in a relational database (e.g., Postgres, MySQL), an unstructured database (e.g., MongoDB, MinIO), or on a filesystem via SQL-compliant interfaces, with data organized in relational schemas. The virtual layer may support standard SQL queries across nodes without needing to aggregate data centrally. The nodes may also apply security, access control and data sharing policies.

In another embodiment, an interface for executing queries, invoking services, or performing service orchestration is provided through an MCP server, which mediates requests, manages contextual information, and coordinates interactions among models, agents, and computing nodes in accordance with an MCP protocol.

The MCP server functionality extends the services provided by the nodes in the network, and therefore nodes in the network are able to receive requests via the MCP protocol, interpret such requests as queries or tasks against the virtual data lake, initiate orchestration processing based on shared metadata, coordinate execution across one or more participating nodes, aggregate returned results, and provide a unified response to the requesting MCP server or client.

The present systems and methods for decentralized intelligence may comprise a method of federated machine learning. This process is a decentralized machine learning approach where multiple devices or edge nodes collaboratively train a model without sharing their raw data. Instead of sending data to a central server, each participant trains a local model on its own data and only shares model updates (e.g., gradients, weights) with an aggregator node. The aggregator may not be aware of the data but is able to use the received model parameters from each of the participating nodes to create or update a global (also “final”) model.

In another embodiment, the role and function of an aggregator node may be distributed among participating nodes, such that each participant is configured to collect sub-models, model parameters, or updates from one or more other nodes in the network and to independently generate, update, or maintain a global or primary model based on the model parameters it receives.

A key feature of this process improves data privacy due to no raw data transfer. In the present federated learning approach, the raw data never leaves the local device/machine. Not exposing the raw data reduces the risk of privacy breaches and enables data sovereignty. Additionally, within this federated learning environment, local models may develop specialized models whose parameters are tailored to local data.

The process for generating a global (also “final”) model within a federated learning environment may be as follows: First, a global model may be created and distributed to participating network members. Next each network member may train the model on its own local data, generating a sub-model in the process. The trained sub-models may then be sent to an aggregator. The aggregator may then update the original global model based on the received sub-models. This updated global model may then be sent back to the network members.

Use cases of federated learning may include but are not limited to healthcare, autonomous vehicles, finance, smartphone and decentralized physical infrastructure network (DePIN) contexts.

In another embodiment, the system and methods provided herein introduce a federated machine intelligence architecture that enables factory machines to be controlled by autonomous software agents capable of learning, adapting, and coordinating in real time.

Machines may be connected to one another via edge nodes providing a shared metadata layer. The shared metadata layer may identify the location of the needed data and provide access to all the distributed data across the edge devices/machines whereas the physical data remains local at its source. Applications may access and query the network as if data was centralized all while data remains in its original location.

Artificial intelligence (AI) agents may each be assigned to a node, a process, an individual machine or subsystem. These agents may be trained and continuously updated using a combination of (i) local machine data (e.g., telemetry, status, sensor streams, video or image streams); (ii) data from neighboring and/or peer machines via the shared metadata layer and the virtual data layer; (iii) application-level data (e.g., production targets, process rules, failure events); and (iv) other agent’s outputs and behaviors enabling collaborative learning and coordination.

As previously mentioned, this data is made accessible via a virtual data layer (also “virtual data lake”) which abstracts the physical location of data and makes it available to authorized participating agents/nodes in real time. Agents may reason about current state, predict future behavior and autonomously coordinate with network members without having to transfer raw or large amounts of data to a centralized location, and while keeping sensitive data in its original location.

In some embodiments, agentic artificial intelligence is enabled to operate against the virtual data lake by providing agents with logical, metadata-driven access to distributed data through the virtual data layer. An agentic AI may issue queries or task requests to the virtual data lake via an MCP server or orchestration node, without requiring knowledge of the physical location, ownership, or storage modality of the underlying data. The orchestration node interprets the requests using shared metadata, identifies participating nodes that host relevant data, coordinates distributed execution, and returns unified results to the agent. This enables the agentic AI to perceive global system state, reason over distributed data, and initiate actions or subsequent tasks based on consistent, centralized-like query semantics, while the data remains locally stored at the edge. As a result, autonomous agents may operate in closed-loop fashion—observe, query, infer, and act over a data-aware network without centralized data aggregation.

Properties of the system (decentralized network providing AI agents for industrial automation) may include (i) data processing happens at or near the data source; (ii) each node retains control over its data; (iii) artificial intelligence model (agents) which are able to make decisions based on up-to-date, multi-source information; (iv) maintaining data sovereignty as data remains in-place allowing data owners to maintain full control of their data; and (v) improved scalability to support increased data capacity, wherein only queries and result sets are transferred over the network and wherein new nodes may be added to the network and new agents or services may join, query, and contribute to a virtualized or logical layer without requiring reconfiguration of the underlying infrastructure or causing material degradation to network performance. This architecture enables seamless, intelligent coordination across machines creating the foundation for federated learning, real-time optimization, and fully autonomous factory operations.

The system and methods provided herein may support (i) peer-to-peer communication between agents; (ii) real-time closed loop decision making; (iii) federated learning, where models are trained locally and insights may be shared globally; (iv) plug-and-play deployment with minimal reconfiguration; and (v) decentralized operation, reducing latency and avoiding external vulnerabilities; (vi) exploring the data and its location by examining the shared metadata. This architecture overcomes the limitations of existing solutions and provides fully autonomous, self-optimizing industrial environments.

### AGENTS

Each software agent deployed in the system may represent one or more physical machines, nodes or processes (e.g., sensors, PLCs, gateways, embedded controllers, industrial servers, or any compute-enabled device).

These agents are decoupled processes that operate on the virtual data layer and may be capable of the following: (i) each agent may have direct access to the data streams and control interfaces of its host machine. Agents may interact with the virtual data layer to read data from distributed tables and write updates to tables (e.g., inserting rows, modifying tables). When an agent writes data to a node, that data is stored locally on the node and immediately indexed and is made available to other agents or processes via the virtual data layer. For example, agents may monitor parameters such as temperature, vibration, utilization, fault codes, geo-coordinates, and energy consumption. For the monitoring process, the agent can issue a query to a node in the network or leverage the MCP interface to issue a semantic request for the needed data and the node would orchestrate the query to return the unified reply using the query method to the distributed data as described above. This may allow the agent to maintain an accurate real-time model of the machine’s internal state and network topology; (ii) agents may communicate with one another using peer-to-peer infrastructure. This allows them to share status updates, coordinate actions, and negotiate workflows or hand-offs independent of a central controller; (iii) when an agent detects overload, fault, or inefficiency, it may negotiate with peer agents to shift tasks. For example, if a packaging machine reaches a thermal threshold, it can offload jobs to a peer with available capacity; and (iv) each agent can run machine learning inference models locally using real-time data from the virtual layer. In training scenarios, agents can participate in federated learning where local model updates are shared with a coordinator (which may itself be an agent) to improve a global model without ever exposing raw data (which may reduce bandwidth utilization).

Agents may be capable of receiving and processing requests over a network using their local compute and storage resources. For example, an agent may receive a request to compute the average temperature from a connected sensor over the past hour and fulfill the request by querying a local database that stores time-series sensor readings.

In addition to performing local processing, an agent may communicate with a node in the network by submitting a query or task request to the node. The receiving node may operate as an orchestration node and, in response to the request, perform metadata-driven orchestration as described herein, including identifying participating nodes, coordinating distributed execution, aggregating results, and returning a unified response to the agent.

In some embodiments, an agent may itself assume the role of an orchestrator. In this capacity, the agent may receive a higher-level request, such as a request to calculate an aggregate metric across a plurality of distributed data sources. Based on policies and metadata published to a shared metadata layer, the agent identifies relevant nodes or agents, dispatches sub-requests to such nodes or agents to perform local computations, and aggregates the returned responses to generate a final result. The final result is returned to the requesting application or agent with semantics equivalent to execution on a single centralized system or unified namespace, while the underlying data remains distributed.

### EDGE AGENT COMPONENTS

Agents may comprise or facilitate the following components: (i) data collection modules which may interface directly with local devices, sensors, databases, or control systems to capture raw telemetry, status updates, or event data in real time; (ii) data indexing engines which may organize ingested data using schema-aware indexing, enabling fast, fine-grained querying over local datasets without external dependencies; (iii) query execution engines which may parse and locally execute distributed subqueries received as part of larger queries, supporting decomposed query processing within overlay subnetworks; (iv) artificial intelligence (AI) inference modules which may execute machine learning model tasks (e.g., anomaly detection, classification, predictive maintenance) directly at the edge using local data, without transferring it to centralized systems; (v) metadata synchronization service modules which may continuously update and add metadata policies on the shared metadata to facilitate sharing and exchange of schema definitions, node capabilities, and policy information with other agents in the network. These services ensure global consistency of the distributed metadata layer, facilitating dynamic discovery and overlay subnetwork formation; and (vi) a native or embedded MCP server configured to service queries, instructions, or requests via natural language interaction, including through an agent, application, or artificial intelligence tool such as a large language model (LLM).

In the system of the invention, agents serve as an intermediary between artificial intelligence modules and network operations. An agent couples AI capabilities (e.g., model execution, inference, learning, and reasoning) with network-aware functions (e.g., metadata synchronization, query orchestration, overlay subnetwork participation, inter-node coordination). Through this coupling, AI modules may consider data regarding network state, data availability, policies, and peer nodes.

Agents may translate AI-driven intents or decisions into network actions (e.g., issuing queries, initiating distributed tasks, updating data and metadata, forming overlay subnetworks, or coordinating with other agents), and conversely exposes network-derived data, metadata, and results to AI modules for reasoning and decision-making. As a result, the agent serves as a bidirectional interface that enables agentic artificial intelligence to operate coherently over a data-aware network and a virtual data lake, without requiring centralized control or data aggregation.

A distinguishing feature of the invention is the ability for agents to operate directly against a virtual data lake that represents distributed data as a single logical resource, while the data remains physically stored at multiple edge nodes. Unlike conventional systems in which agents or AI processes operate only on data local to a single node or require prior aggregation of data into a centralized repository, the agents of the invention issue queries and task requests against the virtual data lake itself.

The virtual data lake, in combination with shared metadata and orchestration processes, enables such agent-issued requests to be decomposed, routed, and executed across multiple nodes that host relevant data (while the physical data remains in-place). Each node performs local computation on its own data and returns a result(s), which are aggregated to produce a unified response for the agent. At no time is raw data centralized, replicated, or moved to a common storage system.

This capability uniquely enables artificial agentic intelligence to reason, infer, and act based on a system-wide view of data that is logically unified yet physically distributed. As a result, agents can perform global analysis, coordination, and decision-making across the network with centralized-like semantics, while preserving data locality, reducing network overhead, and maintaining compliance with data governance and sovereignty constraints.

### SHARED METADATA

In the context of this application the phrase “shared metadata” (also “shared metadata layer” or “shared metadata repository”) may be used to describe the decentralized ledger that serves as a centralized repository of critical information that is accessible to all nodes within the network. It functions as a shared drive, enabling seamless collaboration and communication across the distributed infrastructure. This metadata includes details about data availability, data location, schemas, query execution plans, node status, and more, ensuring all participants in the network operate with consistent and up-to-date information. The shared metadata may be deployed in several ways. First, the shared metadata may be stored and managed on a blockchain ensuring immutability, transparency, and decentralized access control. Each update to the metadata may be treated as a transaction, ensuring a verifiable and tamper-proof history of changes. Nodes may independently verify the authenticity of metadata, making this implementation ideal for environments where trust is distributed. In another embodiment, the shared metadata may be maintained by a master node that acts as a blockchain emulator. In this case, the master node may mimic the functionalities of a blockchain by managing updates, verifying authenticity, and distributing metadata changes to all nodes. While not fully decentralized, this approach enables complete operation within a closed or internal environment, supports deployment within isolated networks (e.g., within a VPN, overlay network, or firewall), and ensures system control and data sovereignty while minimizing reliance on external infrastructure or dependencies.

The shared metadata layer may not only enable query federation and schema discovery but may also serve as the control plane for managing policies across distributed nodes, machines, and agents. Every node in the system/network may contribute to and access the shared metadata layer (also “distributed metadata catalog”, “metadata layer”, “shared metadata” or “metadata”). The shared metadata layer may include: (i) schema definitions (e.g., tables, columns, types, units); (ii) data availability (e.g., time ranges, frequency, retention); (iii) node capabilities (e.g., processing, storage, sensors connected); (iv) agent identities and their registered roles; (v) data locations (to identify nodes by the data they host); (vi) configuration policies; and (vii) system state updates (e.g., errors, maintenance events, operational modes). The aforementioned policies published to the shared metadata layer may also detail security protocols or policies, as well as any additional metadata or information that needs to be shared among the nodes in the network.

### POLICIES

In the system of the invention, information maintained in the metadata may be represented in the form of policies. Such policies define rules, constraints, and conditions governing access to data, models, and operations across the network. The policies may specify, by way of example, which nodes, agents, users, or artificial intelligence programs are authorized to access particular data sets or models, the types of operations that may be performed, and conditions under which such operations are permitted.

Policies stored in the metadata may further describe data locality requirements, privacy constraints, governance rules, execution preferences, or resource utilization limits. During query execution, task orchestration, agent operation, or model interaction, the policies are evaluated to guide node selection, overlay subnetwork formation, execution placement, and result aggregation. In this manner, the metadata-driven policies enable consistent, automated enforcement of system behavior across distributed nodes without requiring centralized control or hard-coded configuration.

As used herein, policies encoded in metadata are machine-interpretable and dynamically evaluated, enabling adaptive and policy-compliant operation of agents, orchestration nodes, and artificial intelligence modules.

In the context of this application a “policy” is a digitally signed object (e.g., JSON object) defining permissions, roles, and operational rules. Every node or user that adds a policy may be considered the owner and may sign it with a private key. All policies may be cryptographically verifiable using the owner's public key (e.g., via the RSA algorithm). The root user (e.g., identified by public key) establishes the base trust and privilege model and can delegate authority to other members. Exemplary policies may comprise: (i) what data or signals are shared across the network; (ii) which agents or nodes have permission to access or update specific data; (iii) under what conditions data can be shared (e.g., threshold triggers, time windows); and (iv) who (e.g., what nodes) are notified when changes occur (subscriptions, triggers).

Access to data and services is granted only if a permission path can be traced from the requester to the root user, with no conflicting policies that override or restrict that access.

In some embodiments, the system and methods may additionally comprise a firewall ensuring that data never leaves the network in which the system and methods are implemented. Additionally, in some cases, the systems and methods may comprise a virtual private network (VPN) to isolate the network and restrict external access. These security measures may work in conjunction with the aforementioned public-key cryptography, signed messages, and decentralized policy enforcement.

### SHARED METADATA LAYER VS. VIRTUAL DATA LAYER

It may be helpful to expressively differentiate the shared metadata layer from the virtual data layer. The shared metadata layer and the virtual data layer serve distinct and complementary roles within the system of the invention. The shared metadata layer stores descriptive and prescriptive information about data, models, nodes, agents, and operations, including schema definitions, semantic descriptors, locations, capabilities, and policies governing access, execution, and coordination. The metadata layer does not store or transport the underlying data itself, but instead provides a synchronized, machine-interpretable representation of system knowledge, topology, and ontology that is used to guide decision-making, orchestration, and enforcement across the network.

In contrast, the virtual data layer provides a logical abstraction through which distributed data is accessed and operated upon as a unified resource. The virtual data layer exposes centralized-like query and operation semantics over physically distributed data by interpreting requests using the shared metadata and coordinating distributed execution at the relevant nodes. Whereas the metadata layer defines data types, data locations, data-hosting nodes, and usage policies, the virtual data layer defines the operational mechanisms for data access and processing, including decomposing and distributing queries to relevant nodes, aggregating intermediate results, and returning a unified result set to the process or agent that initiated the query. Together, the two layers enable data-aware network behavior without requiring physical data centralization.

The shared metadata layer may provide a global catalog of data schemas and table definitions across the network (e.g., information on which tables exist on which nodes, time ranges, columns, units, access permissions). This provides for the ability to route, optimize and federate SQL queries and requests based on the relevant data’s location.

The virtual data layer, as previously stated, is the abstraction of the raw data contained in the network and data’s location stored on the shared metadata layer, may provide for many of the same benefits as centralized, or cloud network architecture without the associated pitfalls.

### VIRTUAL DATA LAYER

In this architecture, intelligent agents may communicate through a shared virtual data layer. This virtual layer allows for (i) real-time synchronization; (ii) context-aware interactions (meaning agents may query state, events, and availability across peers nodes using standard query mechanisms, such as SQL, or semantic requests issued via an MCP protocol, without needing data replication or centralizing data); (iii) mediation of context-aware queries and service interactions by an MCP server, wherein the MCP server maintains or accesses contextual metadata, routes queries or requests to relevant peer nodes, and coordinates responses without requiring centralized aggregation or replication of underlying data; (iv) security and ownership policies that are enforced at the data layer, which allow agents to share only what’s authorized, maintaining privacy across departments or organizations; and (v) autonomous coordination, meaning that agents may negotiate workloads, report anomalies, and adapt to dynamic conditions through local decisions enabled by globally visible but locally stored data. These capabilities allow for a fully automated, “lights-off” factory environments in which machines coordinate, optimize, and self-govern without a centralized orchestrator.

### P2P NETWORK

Upon deployment, agents may autonomously join a permissioned peer-to-peer (P2P) network. This fabric serves as the foundational communication and coordination layer for the distributed system. The network enforces strict identity verification, cryptographic authentication, and role-based access control, ensuring that only authorized and authenticated nodes are permitted to participate.

Within the P2P network nodes may publish their capabilities, including but not limited to available datasets, supported query types, AI inference services, alternative data services such as data collection, storage, processing and transformation, analytics and visualizations, resource availability, and hardware constraints, thereby enabling dynamic discovery by peers. In one embodiment, these services are published on the shared metadata.

Node data/capabilities (e.g., schema definitions, data types, indexing structures, policy rules) may be continuously synchronized across all participating nodes through a distributed ledger or decentralized metadata store. This ensures that queries and services remain interoperable, even in highly heterogeneous environments.

Each node may expose a local query interface conforming to a shared protocol. Applications or other agents may submit requests to any node, which dynamically plans and routes subqueries across a relevant overlay subnetwork.

In another embodiment, the interface for submitting queries or orchestrating services is provided through an MCP server that mediates requests, manages contextual information, and coordinates query execution or service interactions across participating nodes in accordance with an MCP protocol.

In another embodiment, the relevant network need not comprise a formal overlay network, and instead may include a dynamically identified subset of nodes that provide data services, manage data locally, or otherwise are determined to be relevant for satisfying the request.

Upon receiving a data or service request, the receiving node (i.e., any edge node) may instantiate a temporary overlay subnetwork (a dynamic subset of nodes selected based on metadata relevance, i.e., nodes hosting relevant data or services). This subnetwork facilitates targeted services orchestration, query execution, or federated learning without global or centralized coordination.

All communication may occur directly between nodes over encrypted channels, bypassing centralized brokers or cloud intermediaries. This minimizes latency, preserves data locality, and enables robust operation even in bandwidth-constrained or intermittently connected environments.

The peer-to-peer communication may comprise a mailbox indexed by channels that provides a persistent, type-aware mechanism for asynchronously initiating services, processes, or configuration changes on any edge node. The mailbox may be accessed by localized services and applications.

In the system of the invention, the network operates as a data-aware network rather than as a passive data transport infrastructure. A data-aware network maintains knowledge, via a shared metadata layer, of the existence, structure, semantics, location, and governance policies associated with data, models, and operations distributed across the network. Network behavior is therefore informed by data characteristics and policies, rather than being limited to endpoint addressing or packet-level routing.

In a data-aware network, requests such as queries, tasks, or artificial intelligence operations are interpreted and executed based on the data they reference. Using shared metadata, the network identifies nodes that host relevant data, dynamically forms overlay subnetworks, and coordinates execution of operations at or near the data sources. Results are aggregated and returned with centralized-like semantics, while the underlying data remains distributed and locally stored by each node and is thus not centralized. In one embodiment, the network itself enforces a data-centric communication model in which requests are issued without reference to destination nodes and instead identify the data to be retrieved, for example via a declarative query. The network resolves the request using shared metadata, routes the request to data-hosting nodes, and returns responses from relevant participants, thereby making data awareness an intrinsic property of the network.

This data awareness enables intelligent network-level functions, including distributed querying, agent coordination, federated learning, and interaction with large language models, to be performed efficiently, securely, and in compliance with policy constraints. As a result, computation, reasoning, and decision-making are driven by data context rather than by static network topology, thereby transforming the network into an active participant in data processing and intelligence.

### P2P ONBOARDING PROTOCOL

The system may comprise an onboarding protocol that allows for any new edge node to integrate into the permissioned P2P fabric without manual configuration. New nodes may locate peers via decentralized discovery beacons or via the decentralized, shared metadata layer, eliminating reliance on central registries. Each node may advertise its data sets, schemas, ML models, and service endpoints, making its resources immediately discoverable. New system nodes may be automatically inserted into overlay-routing and workload-balancing tables, so future system requests may leverage the new node’s compute, storage, or actuation capabilities.

### P2P SCALABILITY

The distribution of queries, model deployments, and control tasks may be guided/informed by data received from nodes (e.g., real-time data) maximizing resource utilization and overall throughput across the fabric.

In the event that a system node becomes unreachable, overlay-routing logic may redirect sub-queries to known/surviving replicas or alternative nodes, maintaining service continuity.

In the event that data replication is unavailable or incomplete, the system may still in some cases return partial results tagged with provenance and fault metadata, giving clients (e.g., query requesters, applications) transparency into data completeness.

### P2P MESSAGING

System clients (e.g., applications, services, agentic AI processes) may exchange information through a secure peer-to-peer messaging layer that provides end-to-end encryption, mutual authentication, and message-integrity checks. Because system traffic never traverses a centralized cloud relay, the architecture may deliver: (i) low latency and minimal bandwidth use given that data only moves between the producing and consuming edge nodes, avoiding centralizing edge data as well as long cloud round-trips allowing reduced network load; (ii) enhanced privacy and data sovereignty as raw data remains local and access control rules are enforced by decentralized policies; and (iii) higher operation resilience as communication may be enabled even in instances when cloud links would be slow, intermittent, or unavailable.

The present system and methods may additionally integrate gateways, software and protocols speaking Modbus, OPC UA, MQTT, etc. These components may join overlays with minimal effort, allowing modern services to span brown-field and green-field deployments alike.

### ENHANCED SECURITY

As previously stated, it is an object of the invention to provide for improved security. The systems and methods disclosed herein provide for a decentralized federated learning environment that eliminates data exposure and security risks associated with present solutions. Security mechanisms of the present system and methods may include but are not limited to the following. The present system and methods may enable edge nodes to query and process local data without transferring the raw data to a central server, as data remains at its original location, the risk of unauthorized access is mitigated. The present system and methods may additionally leverage blockchain technology to maintain an immutable record of model exchanges and network actions (e.g., training instructions, sub-model and final model creation). Sub-models and final models may be stored as cryptographically secured metadata, ensuring integrity and traceability. The present system and methods may additionally support differential privacy and secure multi-party computation (SMPC) to ensure that individual data points are never reconstructed or exposed. Homomorphic encryption may be applied to sub-model updates, allowing for computation on encrypted data. Furthermore, instead of relying on a single aggregation node/server, model aggregation may also be performed collectively by multiple edge nodes. This may mitigate the risk associated with a single point of failure and minimize adversarial attacks (e.g., model poisoning). Strict authentication and authorization policies may be enforced on nodes within the federated learning network. Only nodes that are properly verified may be able to publish/pull models to the shared metadata, thereby preventing unauthorized entities from injecting malicious models into the system. Lastly, the system and methods may provide for a more secure model deployment methodology. Given that models are stored and distributed via an immutable metadata network, unauthorized modifications are prevented. Additionally, nodes may verify model authenticity prior to implementation, ensuring that only trusted versions are utilized.

Within the provided decentralized network infrastructure, federated learning may be made more secure and transparent, making it ideal for internet of things (IoT), industrial IoT, smart home, smart city, finance and industrial automation applications.

### EXAMPLARY USE CAES

1. Servicing data to AI Agents
A compressor (e.g., an edge machine) detects and generates vibration anomaly data, which is streamed to a local edge node. The associated node publishes, to a shared metadata layer, descriptive information indicating the type of data being collected, along with applicable access and usage policies.
A maintenance agent, subject to applicable authorization or access controls, submits a query to a virtual data layer to identify and access relevant data. The maintenance agent applies one or more AI models to analyze the data and detect a condition, event, or anomaly, and, in response to such detection, initiates a coordinated task delegation or collaboration workflow with one or more neighboring or peer agents to perform further analysis, verification, or remediation actions.
This process is performed without involving a centralized cloud service and without disclosing sensitive internal machine parameters beyond the scope defined by the embedded policies. By combining shared metadata with enforceable policy definitions, the disclosed system and methods enable secure, scalable, and controlled peer-to-peer coordination, allowing machines, agents, and processes to interact intelligently while preserving data ownership, operational privacy, and regulatory compliance.

2. Adding A New Machine
Another exemplary use case of the present system and methods includes integration of a new labeling machine into a production line. In such cases, an edge node is deployed at the labeling machine and interfaces with its sensors and controller. The edge node automatically generates a policy representing operational capabilities of the machine, and a data schema (if it does not pre-exist) including, for example, labeling throughput, error conditions/codes, and consumable usage metrics, and publishes the policy and data schema to a shared metadata layer together with associated access and control policies.
A labeling agent is deployed at or near the edge node. The labeling agent queries a virtual data layer, registers its presence within the network, and begins monitoring and controlling the labeling machine based on the published metadata and enforced policies.
When an upstream bottleneck condition is detected by another agent in the production line (for example, a printing agent), the upstream agent transmits a coordination signal to the labeling agent. In response, the labeling agent dynamically adjusts its operating parameters, including labeling speed and synchronization behavior, to maintain end-to-end flow optimization.
The labeling agent may further execute a predictive maintenance model locally and periodically transmit model updates or learned parameters to a federated learning coordinator, without transferring raw operational data. No centralized control system is required, and no modification to existing infrastructure is necessary. As a result, the newly added machine becomes a fully participating node in the intelligent peer-to-peer network within minutes.

3. Real Time Load Balancing
Another exemplary use case of the present system and methods may include real-time load balancing within a packaging line. Suppose a packaging facility operates multiple machines, three labeling units, two sealers, and one inspection station. Each machine may be equipped with a node and represented by a dedicated software agent.
Each node may pull data from the machine’s PLC and sensors (e.g., status, throughput, fault logs). The nodes may then contribute their schemas to the shared metadata layer, enabling unified data discovery. The software agents (also “AI agents”) may register themselves, query operational data through the virtual data layer, and start monitoring workflows.
One of the labeling units (e.g., labeler-3) may begin to show signs of overheating based on its sensor data. Its agent may therefore: (i) query historical vibration and temperature trends from its own node; (ii) retrieve real-time performance metrics from the other two labeling agents; and (iii) determine that labeler-3 will soon exceed its safe operating threshold. The agent may, in response, publish an alert to the virtual data layer. The agent may negotiate task reallocation with the labeler-1 and labeler-2 agents using peer-to-peer messages. Furthermore, an upstream sealer (package sealer) agent may adjust timing automatically to compensate for the reduced labeling capacity due to labeler-3 overheating. The labeler-3 AI agent may also send a control signal to throttle labeler-3 speed. The labeler-3 AI agent may also run a prediction module to predict when the unit (labeler-3) can resume full operation. Other agents may rebalance the load dynamically, without human intervention or cloud orchestration. Access to labeler-3’s fault data is granted only to maintenance agents with appropriate permissions defined via metadata policies. In this situation, data generated by machines and agents is made available within a virtual data layer, such that transmission of raw telemetry to a cloud environment is not required. In some embodiments, summarized information, alerts, or selected subsets of the data may be shared outside a firewall or trusted boundary if desired and permitted, although such external data sharing is not required in the present invention.

4. Situation Specific Update Protocols
Another exemplary use case of the present system and methods may be situation specific update protocols. Consider dynamic software updates for autonomous vehicles. An update request may be designed to target all self-driving cars that (i) have no passengers, (ii) are parked, and (iii) are currently charging. An orchestrator node may use these criteria to instantiate a metadata search to locate the relevant participants and use the search results to create a temporary overlay subnetwork comprising only the qualifying vehicles. The new software may then be distributed and installed entirely within that overlay. After the first wave, the request can be re-issued with an additional, revised filter (e.g., “all vehicles reporting a software-version tag below Y”) to guarantee that every remaining car receives the update. Each invocation may create a fresh overlay subnetwork, ensuring precise, bandwidth-efficient delivery without touching vehicles that already meet the desired version.
Furthermore, an application may issue a command to distribute a new machine learning model to every edge node in a particular region (e.g., San Francisco) that meets certain criteria (e.g., node advertises an inference-endpoint service for traffic monitoring).
For the following description, it can be assumed that most correspondingly labeled elements across the figures(e.g., 105 and 205, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

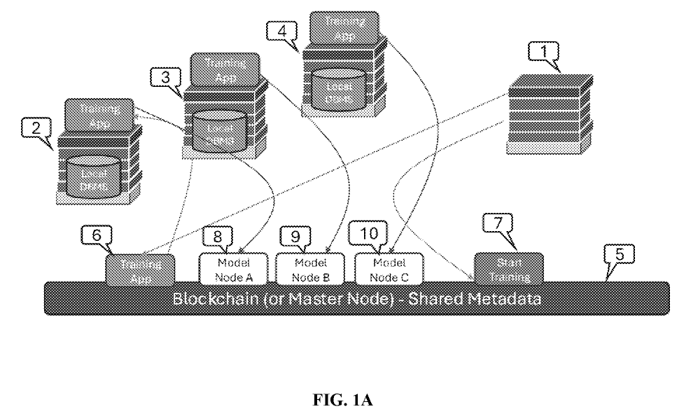

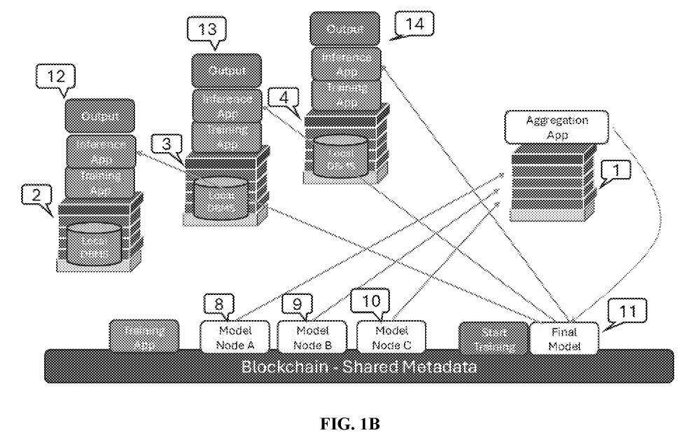

FIGS. 1A-B each depict block diagrams demonstrating a method of federated learning, according to an aspect.

FIG. 1A depicts node 1 which may initiate the process of federated learning by generating training app (also “initial global model”) 6. In some cases, training app 6 may be developed manually (e.g., by a machine learning engineer). The retrieval mechanism of initial global model 6 may be sent to shared metadata 5 (also “blockchain”, “master node” in some cases). After the retrieval mechanism of initial global model is published, an instruction, such as instruction 7, may be published to shared metadata 5. Instruction 7 may include a “start training” command, which may inform nodes participating in the network to train initial global model 6 using their local datasets. Subsequently, based on instruction 7, node 2, node 3 and node 4 may pull initial global model 6 based on the retrieval mechanism from the shared metadata 5. Each of the nodes within the decentralized network may comprise application program interfaces (APIs) that may enable the publishing and reading/retrieving of data from the shared metadata 5. As shown, nodes 2, 3 and 4 each may maintain a local database (e.g., PostgreSQL, SQLite, MongoDB) that hosts data distinct from other nodes. Training app 6 may be modified by each node using each node’s local dataset. The modified training app or sub-model created by each node may then be sent back to shared metadata 5. As depicted in FIG. 1A, node 2 trains the initial global model 6 on its local data in order to create sub-model 8. Node 3 and node 4 may additionally create sub-model 9 and sub-model 10 respectively. The retrieval mechanism of each sub-model may then be published to shared metadata 5. As shown in FIG. 1A, node 2, node 3 and node 4 publish sub-model 8, sub-model 9 and sub-model 10 to shared metadata 5 respectively.

As shown in FIG. 1B, each of sub-models 8, 9 and 10 may then be considered in an aggregation process to generate final global model 11 (“final model”). As shown in FIG. 1B, node 1 acts as an aggregator node in order to generate final global model 11. Node 1 may then publish the retrieval mechanism of the final global model 11 to shared metadata 5. In another embodiment, final model 11 is not generated by an aggregator node, but is instead aggregated by nodes 2, 3 and 4. In some cases nodes 2, 3 and 4 may share and read one another’s sub-models and may act to generate final model 11 collectively. Following the creation and publishing of final model 11, node 2, node 3 and node 4 may pull final model 11 using the retrieval mechanism written to the shared metadata 5. Final model 11 may then process the local data at each of nodes 2, 3 and 4 in order to generate output 12, output 13 and output 14 respectively. Output may involve an action to be taken by a particular node or edge device.

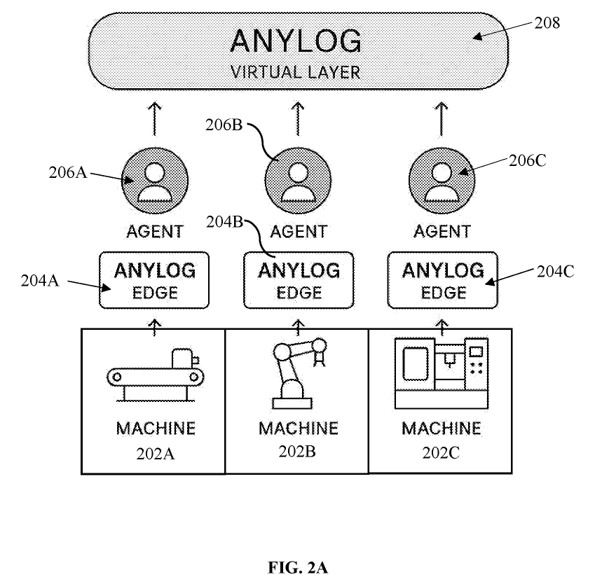

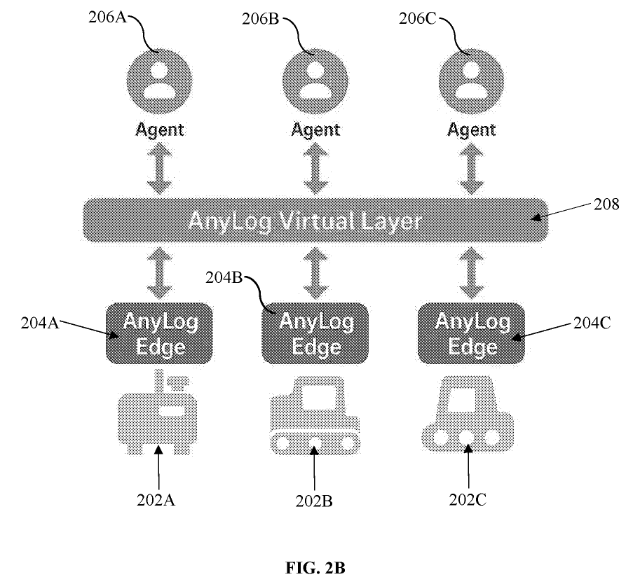

FIGS. 2A-B each depict a block diagram of system architecture, according to an aspect.

FIG. 2A illustrates a block diagram of system architecture, according to an aspect. Edge industrial machines 202A-C may be deployed across a factory environment. Each machine is connected to an edge node such as edge nodes 204A-C. Edge nodes 204A-C may be a software component that interfaces with the machine’s native protocols (e.g., OPC UA, Modbus, MQTT) and enables localized data handling. As shown, the edge nodes may additionally be in communication with artificial intelligence agents 206A-C (also “AI agents” or “software agents”). Software agents 206A-C may represent logic engines or applications that interact with the virtual layer. These agents may perform analytics, orchestrate workflows, or execute AI models based on real-time data retrieved directly from the machines via virtual layer 208. Edge nodes and AI agents may be in communication with the virtual data layer 208, which logically unifies the distributed machine data without centralizing it. This layer abstracts the location of data and allows applications or services to query the network as if it were a single, centralized database while the data remains distributed across machines

A key innovation in this system is its support for bidirectional intelligence enabling not only data acquisition from machines, but also dynamic control, coordination, and adaptation based on real-time decisions made at the edge. These decisions may include but are not limited to (i) task parameters (e.g., speed, timing, thresholds); (ii) mode changes (e.g., maintenance mode, standby); and (iii) coordination signals (e.g., delegation, alert escalation). Edge nodes may interpret these writes and relays them to the appropriate control interface (e.g., PLC or device controller) of the host machine. This bidirectional intelligence supports a closed-loop control system, where machines generate telemetry, agents analyze and infer actionable insights and updates are pushed back to machines to optimize behavior in real time. For example, a packaging machine’s agent may detect a throughput bottleneck via sensor readings. The agent may then calculate a revised feed rate using a local ML model (agent). It may then write the updated parameter to the node’s control table. Finally, the node may apply the update to the machine's PLC.

FIG. 2B depicts a block diagram of system architecture, according to an aspect. FIG. 2B depicts many of the same network components as presented in FIG. 2A, however as shown, FIG. 2B depicts the capacity of bidirectional messaging between software agents 206A-C and machines 202A-C. As previously stated, this enables closed-loop intelligence meaning agents not only access machine data but also send instructions, configuration updates, or model outputs back to the machines in real time. The aforementioned bidirectional operations rely on a shared metadata layer, which governs data visibility, access permissions, and operational coordination across the system. This shared metadata layer can be implemented as either a dedicated node serving as a metadata coordinator, or a blockchain-based ledger acting as a decentralized, tamper-resistant registry for policies, schemas, access control, and audit trails. This flexibility allows the system to adapt to centralized, federated, or fully decentralized governance models depending on the trust model and scale of deployment. Regardless of the implementation, the shared metadata layer acts as a distributed control plane, ensuring transparency, verifiability, and traceability across the network.

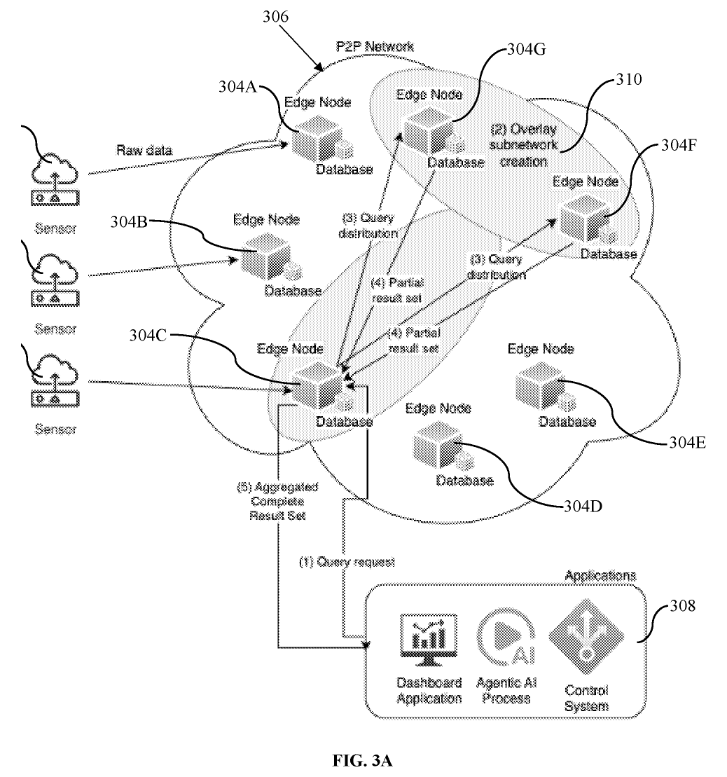

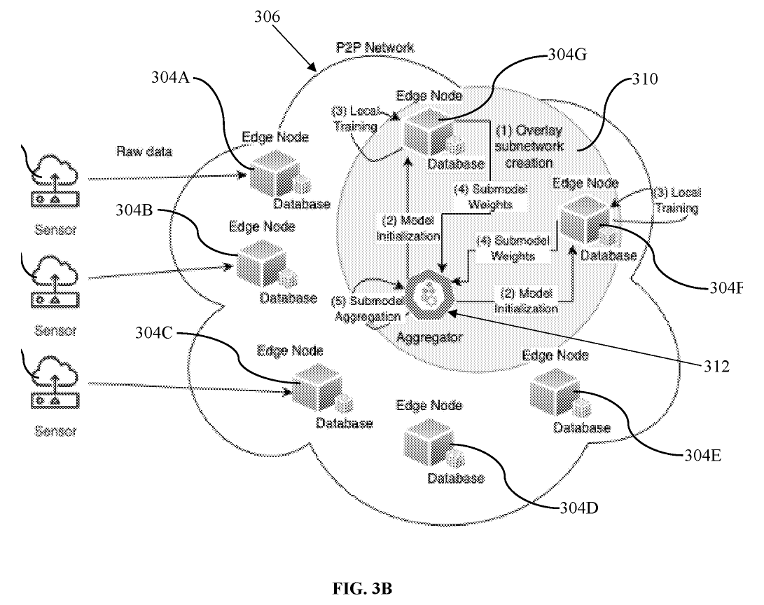

FIG. 3A depicts a diagram of system architecture, according to an aspect. As shown, FIG. 3A depicts the process of returning query result sets within P2P network, according to an aspect. Edge nodes 304A-G may be connected to sensors 302A-C (also gateways, PLCs, embedded controllers). As shown, sensor 302A is connected to ingress edge node 304A (edge node, ingress node), sensor 302B is connected to edge node 304B, and sensor 302C is connected to edge node 304C. Each of edge nodes 304A-G may comprise an agent (AI agent) and participate in peer-to-peer network 306 (P2P network). Application 308 may comprise any of a dashboard application, an agentic AI process or a control system. Application 308 may issue a query to P2P network 306. The node that receives the query may analyze data received from a shared metadata layer in order to determine the nodes within the P2P network that hold data relevant to the query. As shown, application 308 issues a query to edge node 304C. Edge node 304C may then determine that edge nodes 304F and edge node 304G hold the data relevant to the query. Edge node 304C may then instantiate an overlay network 310 linking only relevant nodes. Edge node 304 may then decompose the original query into smaller subqueries. These subqueries may then be distributed across the overly subnetwork such that only the relevant edge nodes process the required data fragments. Each of the relevant nodes may then return their portion of the query results, their partial result set. As shown, edge nodes 304G and 304F return their partial result sets to edge node 304C. Edge node 304C may then aggregate the partial result sets to create the complete result set and return the result to the original application.

FIG. 3B depicts a diagram of system architecture, specifically, FIG. 3B depicts a P2P network utilizing an overlay subnetwork to link nodes participating in the training of a machine learning model. An initial global model may be published to a shared metadata layer (not shown). Subsequently, an instruction may be published to the shared metadata layer. The instruction may define a “start training” command, that may specify which model is to be trained and by which nodes. In some cases, the nodes which are to train the model specified, may be derived from a separate instruction or log in the shared metadata layer. Upon initiating a federated learning task, an overlay subnetwork may be dynamically instantiated, connecting only the nodes to be involved in the training of the model. As overlay network 310 (also “overlay subnetwork”, “subnetwork”) contains aggregator node 312 (also “aggregator”) as well as edge node 304F and 304G. The initial global model, global model parameters (e.g., weights) may then be distributed, or pulled, by each of the nodes within the overlay subnetwork. Each of the nodes within subnetwork 310 may then retrain the initial global model locally on its own private data. The nodes may then exchange the resulting model updates either (a) upward to a designated aggregator or (b) laterally among peers for decentralized aggregation. In both cases the global model is updated without ever sharing the raw data between nodes. As shown, edge nodes 304F and 304G train the received global model on their local datasets, this raw data remains local, and is used to update model parameters (local sub-models) which are retained for distribution. Depending on system architecture, all local sub-models may be sent to an aggregator node for the creation of an improved global model. The creation of the global model may include aggregation techniques such as weighted averaging. In other cases, edge nodes may exchange their local sub-models with one another within the subnetwork and perform distributed aggregation. These steps may be repeated in order to further perfect the model over time. In some cases, these steps may be scheduled to take place periodically, or in response to an event (e.g., hitting a threshold of new data).

In some embodiments, the present systems and methods for decentralized intelligence networks may comprise a method of industrial automation with improved data security. The method may be operable on a network of nodes wherein each node includes a computer system comprising at least a processor, a memory and a computer program comprising processor-executable instructions stored on a non-transitory processor readable medium. The method may comprise the following steps (i) generating, by an artificial intelligence agent stored on a requesting node, a query, wherein the requesting node is in electronic communication with a machine; (ii) sending, by the requesting node, the query to an orchestrator node; (iii) determining, by the orchestrator node, one or more edge nodes having data relevant to the query by referencing a shared metadata layer; (iv) sending, by the orchestrator node, the query to the one or more edge nodes; (v) generating, by each of the one or more edge nodes, a partial result set based on the query; (vi) sending, by each of the one or more edges nodes, the partial result set to an aggregator node; (vii) generating, by the aggregator node, an aggregated result set based on the partial result sets from participating edge nodes; (viii) sending, by the aggregator node, the aggregated result set to the requesting node; and (ix) modifying, by the artificial intelligence agent, a machine operating parameter on the machine based on the aggregated result set.

In some cases, the method may also comprise instantiating, by the orchestrator node, an overlay network linking the one or more edge nodes having data relevant to the query to the aggregator node, the orchestrator node and the requesting node, wherein the sending of the query and the sending the partial result sets is performed using the overlay network. In other cases, the method may also comprise publishing, by the requesting node, a notification to the shared metadata layer, the notification being based on the modification to the machine operating parameter. The method may also comprise decomposing, by the orchestrator node, the query into at least one subquery. The shared metadata layer of the method may additionally comprise data access permission policies. In some cases, the method may also comprise modifying, by a second artificial intelligence agent, a second machine operating parameter on a second machine based on the notification.

In some embodiments, metadata maintained by the network is accessible to AI agents that operate in conjunction with the managed data. Such metadata may include, without limitation, information identifying the type of data managed, the location of the data within the network, applicable access permissions, and other policy or descriptive attributes available to a node. An AI agent may request said metadata from the network, and the metadata may be provided to the agent in response. The metadata provided to the agent is used as input to the agent’s decision-making process, including determining which data to access, and how to process or reason over the data.

In some embodiments, the present systems and methods for decentralized intelligence networks may comprise a system of (i) a plurality of nodes comprising at least a requesting node, an orchestrator node, one or more edge nodes, and an aggregator node; and (ii) a shared metadata layer. These components may be configured to perform various tasks, for example: (i) the requesting node may be configured to submit a query to the plurality of nodes; (ii) the orchestrator node may be configured to identify one or more edge nodes storing data relevant to the query by referencing the shared metadata layer; (iii) each of the one or more edge nodes may be configured to generate a partial result set based on the query; (iv) the aggregator node may configured to generate an aggregated result set based on the partial result sets of the one or more edge nodes; (v) the aggregator node may be configured to return the aggregated result set to the requesting node; (vi) one of the plurality of nodes may generate a decision based on the aggregated result set; and (vii) one of the plurality of nodes may then modify a machine state, operating parameter or system configuration based on the decision.

In some cases, the orchestrator node may be configured to instantiate an overlay network linking the one or more edge nodes having data relevant to the query to the aggregator node, the orchestrator node and the requesting node. In some cases, the orchestrator node and the aggregator node are the same node. In some cases, the orchestrator node may be configured to decompose the query into at least one subquery. In some cases, the query may be an SQL query and may be generated by an artificial intelligence agent. The system may also further comprise an artificial intelligence agent on the requesting node, wherein the artificial intelligence agent is configured to generate the query and modify a machine operating parameter based on the aggregated result set.

In other embodiments, the system and methods for decentralized intelligence networks may comprise a method of federated learning with improved data security. The method may operable on a network of nodes wherein each node includes a computer system comprising at least a processor, a memory and a computer program comprising processor-executable instructions stored on a non-transitory processor readable medium. The method may comprise the following steps (i) publishing, by a requesting node, an initial global model to a shared metadata layer; (ii) retrieving, by an edge node, the initial global model from the shared metadata layer; (iii) generating, by the edge node, a sub-model based on data stored on the edge node; (iv) publishing, by the edge node, the sub-model to the shared metadata layer; and (v) generating, by an aggregator node, a final global model based on the sub-model.

In some cases the data stored on the edge node may be maintained in an SQL database, a NoSQL database, a CSV file, a TXT file, JSON file or an XML file. In some cases, the shared metadata layer may comprise metadata describing a logical structure or identifier of data stored on the edge node; and a notification mechanism configured to notify one or more nodes in the network when a model or sub-model has been published. In some cases, the method may further comprise publishing, by the aggregator node, the final global model to the shared metadata layer. The method may further comprise retrieving, by the edge node, the final global model from the shared metadata layer. Furthermore, the method may comprise generating, by the edge node, an output based on the final global model. In some cases, this output is based on the data stored on the edge node.

It may be advantageous to set forth definitions of certain words and phrases used in this patent document. The term "couple" and its derivatives refer to any direct or indirect communication between two or more elements, whether or not those elements are in physical contact with one another. The term "or" is inclusive, meaning and/or. The phrases "associated with" and "associated therewith," as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, "plurality" means two or more. A "set" of items may include one or more of such items. Whether in the written description or the claims, the terms "comprising," "including," "carrying," "having," "containing," "involving," and the like are to be understood to be open-ended, i.e., to mean including but not limited to. Only the transitional phrases "consisting of" and "consisting essentially of," respectively, are closed or semi-closed transitional phrases with respect to claims.

If present, use of ordinal terms such as "first," "second," "third," etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, "and/or" means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A method of industrial automation with improved data security, the method being operable on a network of nodes wherein each node includes a computer system comprising at least a processor, a memory and a computer program comprising processor-executable instructions stored on a non-transitory processor readable medium, the method comprising:
generating, by an artificial intelligence agent stored on a requesting node, a query, wherein the requesting node is in electronic communication with a machine; sending, by the requesting node, the query to an orchestrator node; determining, by the orchestrator node, one or more edge nodes having data relevant to the query by referencing a shared metadata layer; sending, by the orchestrator node, the query to the one or more edge nodes; generating, by each of the one or more edge nodes, a partial result set based on the query; sending, by each of the one or more edges nodes, the partial result set to an aggregator node; generating, by the aggregator node, an aggregated result set based on the partial result sets of the participating edge nodes; sending, by the aggregator node, the aggregated result set to the requesting node; and modifying, by the artificial intelligence agent, a machine operating parameter on the machine based on the result set.

2. The method of claim 1, further comprising instantiating, by the orchestrator node, an overlay network linking the one or more edge nodes having data relevant to the query to the aggregator node, the orchestrator node and the requesting node, wherein the sending of the query and the sending the partial result sets is performed using the overlay network.

3. The method of claim 1, further comprising publishing, by the requesting node, a notification to the shared metadata layer, the notification being based on the modification to the machine operating parameter.

4. The method of claim 1, decomposing, by the orchestrator node, the query into at least one subquery.

5. The method of claim 1, wherein the shared metadata layer comprises data access permission policies.

6. The method of claim 3, further comprising modifying, by a second artificial intelligence agent, a second machine operating parameter on a second machine based on the notification.

7. A system comprising:
a plurality of nodes comprising at least a requesting node, an orchestrator node, one or more edge nodes, and an aggregator node; and
a shared metadata layer;
wherein the requesting node is configured to submit a query to the plurality of nodes;
wherein the orchestrator node is configured to identify one or more edge nodes storing data relevant to the query by referencing the shared metadata layer;
wherein each of the one or more edge nodes are configured to generate a partial result set based on the query;
wherein the aggregator node is configured to generate an aggregated result set based on the partial result sets of the one or more edge nodes;
wherein the aggregator node is configured to return the aggregated result set to the requesting node;
wherein one of the plurality of nodes generates a decision based on the aggregated result set; and
wherein one of the plurality of nodes modifies a machine state, operating parameter or system configuration based on the decision.

8. The system of claim 7, wherein the orchestrator node is configured to instantiate an overlay network linking the one or more edge nodes having data relevant to the query to the aggregator node, the orchestrator node and the requesting node.

9. The system of claim 7, wherein the orchestrator node and the aggregator node are the same.

10. The system of claim 7, wherein the orchestrator node is configured to decompose the query into at least one subquery.

11. The system of claim 7, wherein the query is an SQL query.

12. The system of claim 7, wherein the query is generated by an artificial intelligence agent.

13. The system of claim 7, further comprising an artificial intelligence agent on the requesting node, wherein the artificial intelligence agent is configured to generate the query and modify a machine operating parameter based on the aggregated result set.

14. A method of federated learning with improved data security, the method being operable on a network of nodes wherein each node includes a computer system comprising at least a processor, a memory and a computer program comprising processor-executable instructions stored on a non-transitory processor readable medium, the method comprising:
publishing, by a requesting node, an initial global model to a shared metadata layer;
retrieving, by an edge node, the initial global model from the shared metadata layer;
generating, by the edge node, a sub-model based on data stored on the edge node;
publishing, by the edge node, the sub-model to the shared metadata layer; and
generating, by an aggregator node, a final global model based on the sub-model.

15. The method of claim 14, wherein the data stored on the edge node is maintained in an SQL database, a NoSQL database, a CSV file, a TXT file, JSON file or an XML file.

16. The method of claim 14, wherein the shared metadata layer comprises metadata describing a logical structure or identifier of data stored on the edge node; and a notification mechanism configured to notify one or more nodes in the network when a model or sub-model has been published.

17. The method of claim 14, further comprising publishing, by the aggregator node, the final global model to the shared metadata layer.

18. The method of claim 17, further comprising retrieving, by the edge node, the final global model from the shared metadata layer.

19. The method of claim 18, further comprising generating, by the edge node, an output based on the final global model.

20. The method of claim 19, wherein the output is based on the data stored on the edge node.
